(19) United States
(12) Patent Application Publication
(10) Pub. No.: US 2009/0084106 A1
(43) Pub. Date: Apr. 2, 2009

(54) C.I.P for patent application number -- 11/906,464

(76) Inventor: Brian Peter Sandler, West Bloomfield, MI (US)

Correspondence Address: Brian Sandler, 5643 Putnam, West Bloomfield, MI, 48323, US

(21) Appl. No.: 12/082,735

(22) Filed: Apr. 14, 2008

Related U.S. Application Data
(63) Continuation-in-part of application No. 11/906,464, filed on Oct. 2, 2007.

(51) Int. Cl. F03B 17/02; F03B 17/04

(52) U.S. Cl. 60/496; 415/916

(57) ABSTRACT

The amount of buoyancy a object has is based on the amount of liquid the object displaces, and the weight of the object. If a submersed object increases in size its buoyancy increases, and if a submersed object decreases in size its buoyancy decreases. This machine attempts to change the size/buoyancy of a submersed object using only gravity as the energy source.

This is a Continuation in Part application for a invention entitled—A MACHINE TO CONVERT GRAVITY TO MECHANICAL ENERGY. Application Ser. No. 11/906,464 Filing date Oct. 2, 2007

### BACKGROUND OF THE INVENTION

### Field of Invention

The present invention relates to energy production, more particularly converting gravity to mechanical energy and/or heat.

### BRIEF SUMMARY OF THE INVENTION

The improvements are as follows;

1. The Piston-like tanks full of liquid (1) are no longer full of liquid (11). The liquid has been replaced by a heavy metal weight (37) and gas (47).

2. The Piston-in-a-tank (21) no longer fall individually. The Piston-in-a-tank (21) now fall as a continuous column, greatly reducing the drag.

3. There is a breather tube (28), the breather tube allows more gas (47) into the expanding Piston-in-a-tank (21).

4. There are transfer solenoids (24,25,68) to move the rapidly moving Piston-in-a-tank (21)

5. There is a sump pump (40) and a gas valve (46) to remove any liquid (11) or gas (47) that accumulates in the Piston-in-a-tank (20,21).

6. There is a collapsible stop (26) that forces gas (47) into the Piston-in-a-tank (21).

7. There is a heat exchanger (61) and radiator (62) added.

### BRIEF DESCRIPTION OF THE DRAWINGS

FIG. 1 is a side view of the original piston full of liquid in the un-expanded position (1).

FIG. 2 is a side view of the original piston-like tank full of liquid in the expanded position (2).

FIG. 3 is a top view of the original piston-like tank full of liquid.

FIG. 4 is the flow chart for the original invention.

FIG. 5 is the flow-chart for the first machine.

FIG. 6 is a bottom view of the flow-chart.

FIG. 7 is a bottom view of a flow chart. In FIG. 7 there are three transfer solenoids (68), and Three (69) combination rigid track (29), generator (23), and Piston-in-a-tank (20).

FIG. 8 is a side view of the Piston-in-a-tank (21) with the piston (34) in the up position. with the bottom door closed (36).

FIG. 9 is a side view of the Piston-in-a-tank (20) with the piston (35) in the down position. with the bottom door (38) open.

FIG. 10 is a side view of the Piston-in-a-tank (20) with the piston (35) in the down position. with the bottom door (36) closed.

FIG. 11 is a top view of the Piston-in-a-tank (20,21). The Piston-in-a-tank are cylinders.

FIG. 12 is a side view of the collapsible stop in the expanded position (26).

FIG. 13 is a side view of the collapsible stop in the un-expanded position (55).

FIG. 14 is a side view of the bottom solenoid (25) in the un-extended position.

FIG. 15 is a top view of the bottom solenoid (25) in the un-extended position.

FIG. 16 is a side view of the bottom solenoid (25) in the extended position.

FIG. 17 is a top view of the bottom solenoid (25) in the extended position.

FIG. 34 is a side view of the bottom solenoid (25) in the un-extended position after it sucks the liquid (11) out of the way of the falling Piston-in-a-tank (21).

FIG. 35 is a top view of the bottom solenoid (25) in the un-extended position after it sucks the liquid (11) out of the way of the falling Piston-in-a-tank (21).

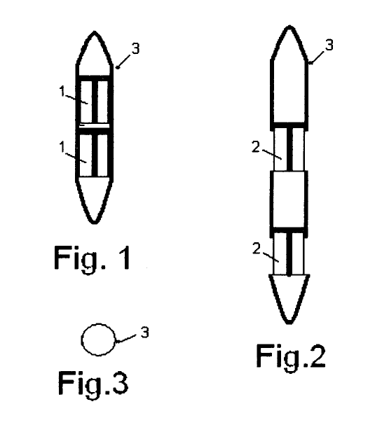

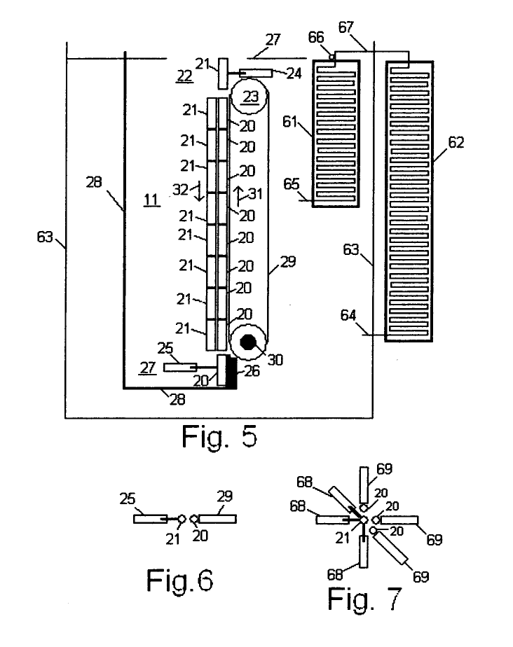

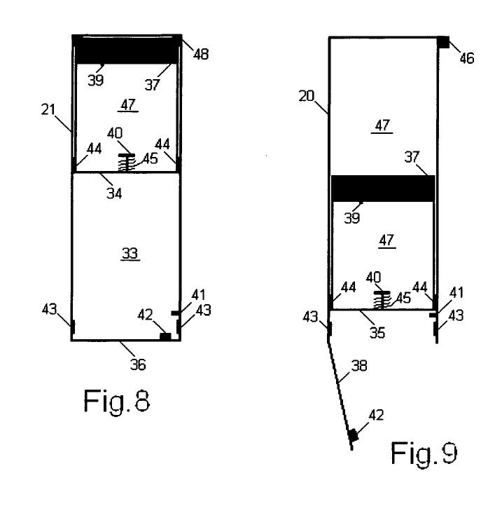

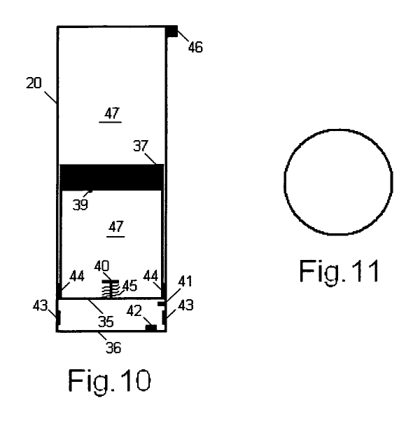

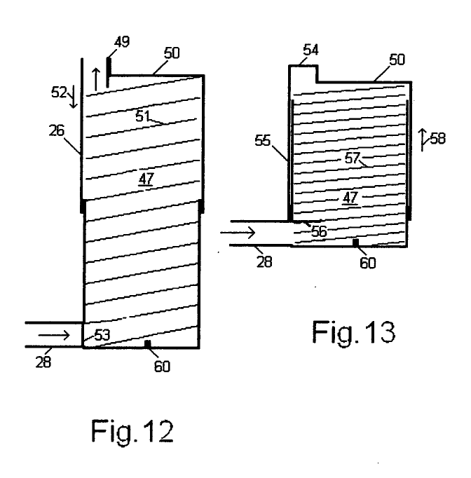

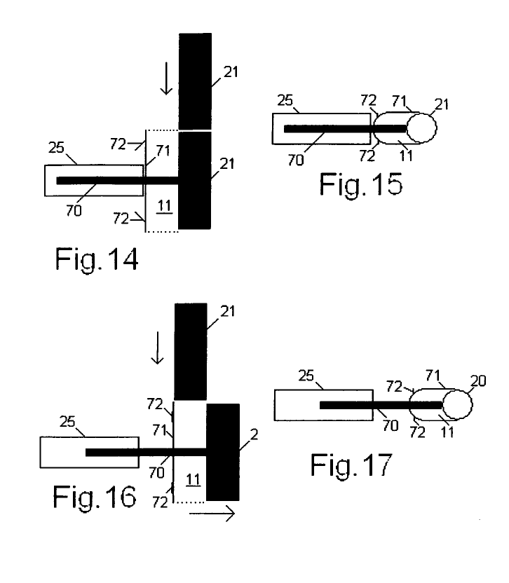

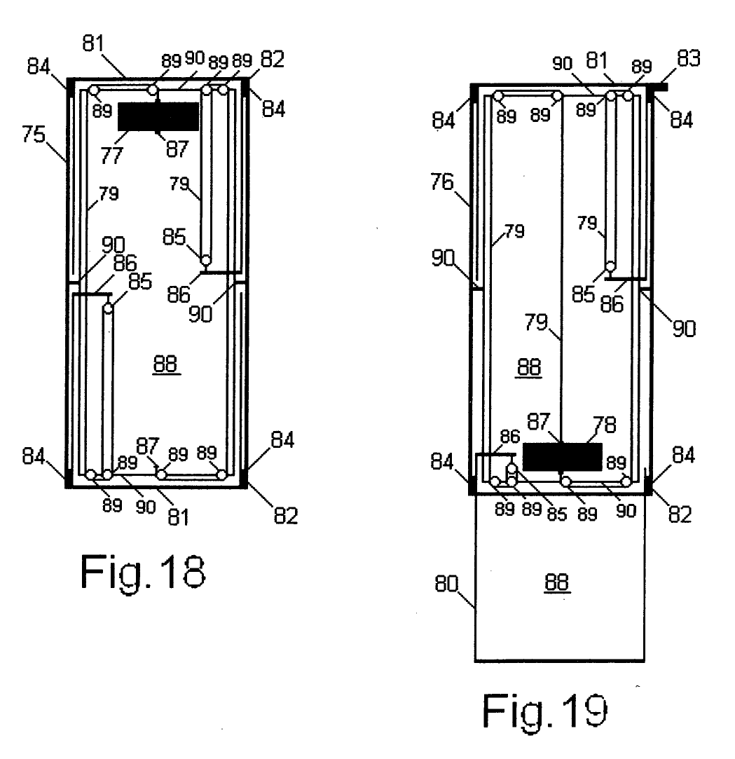

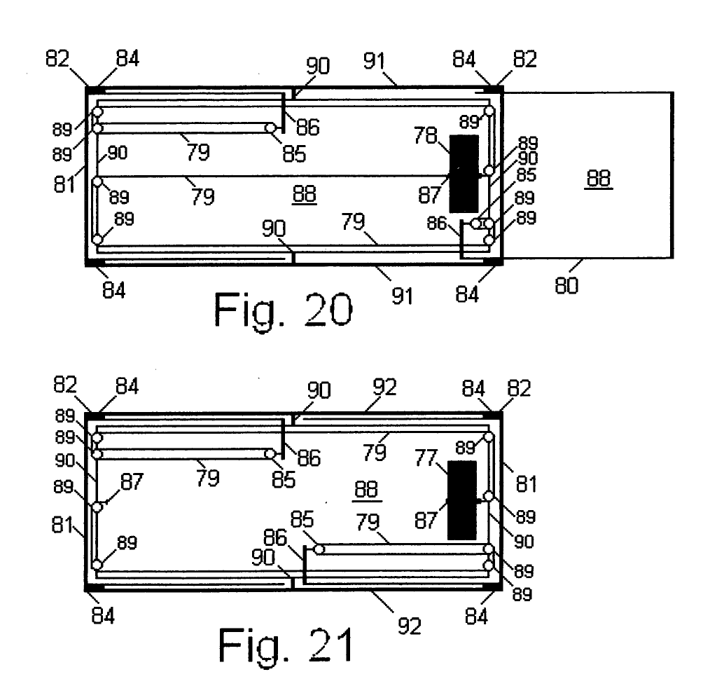

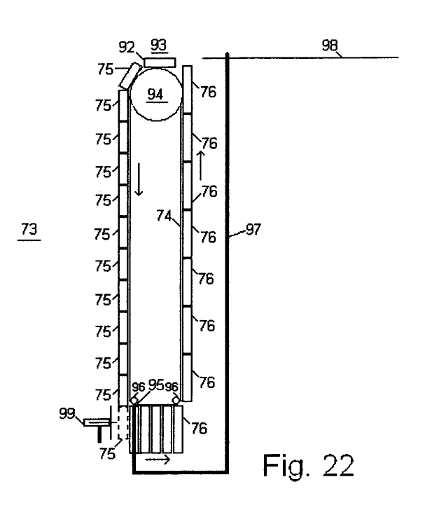

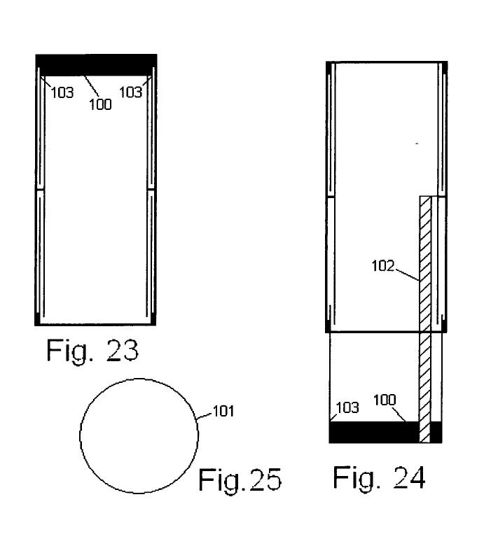

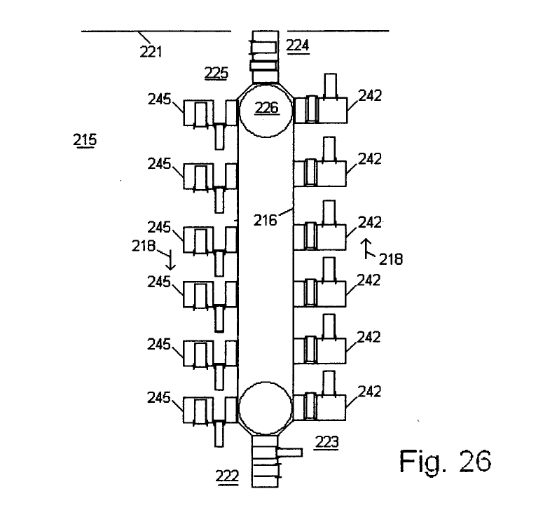

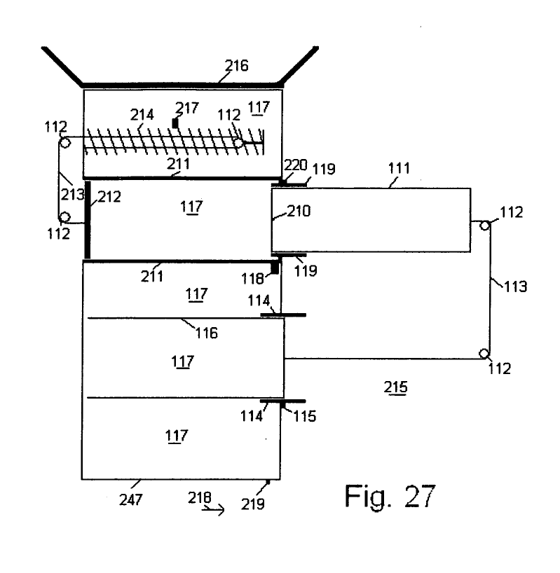

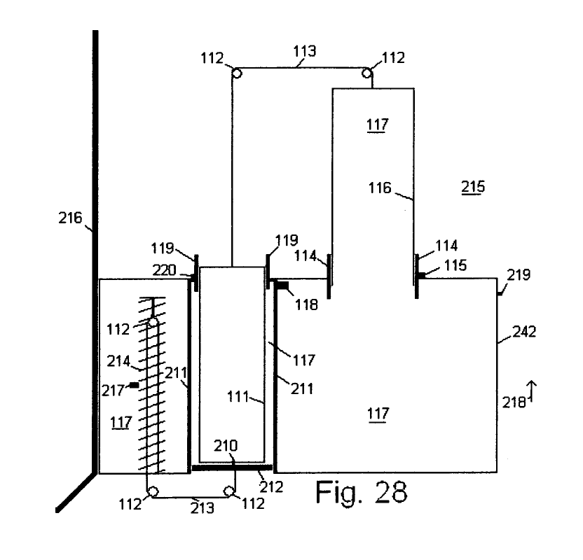

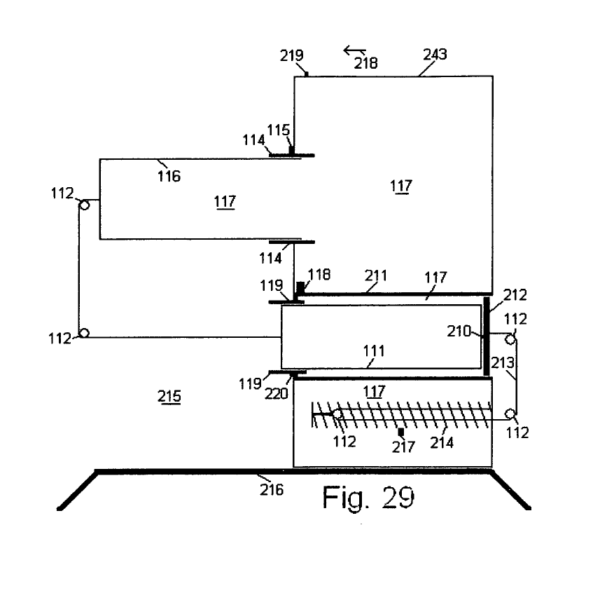

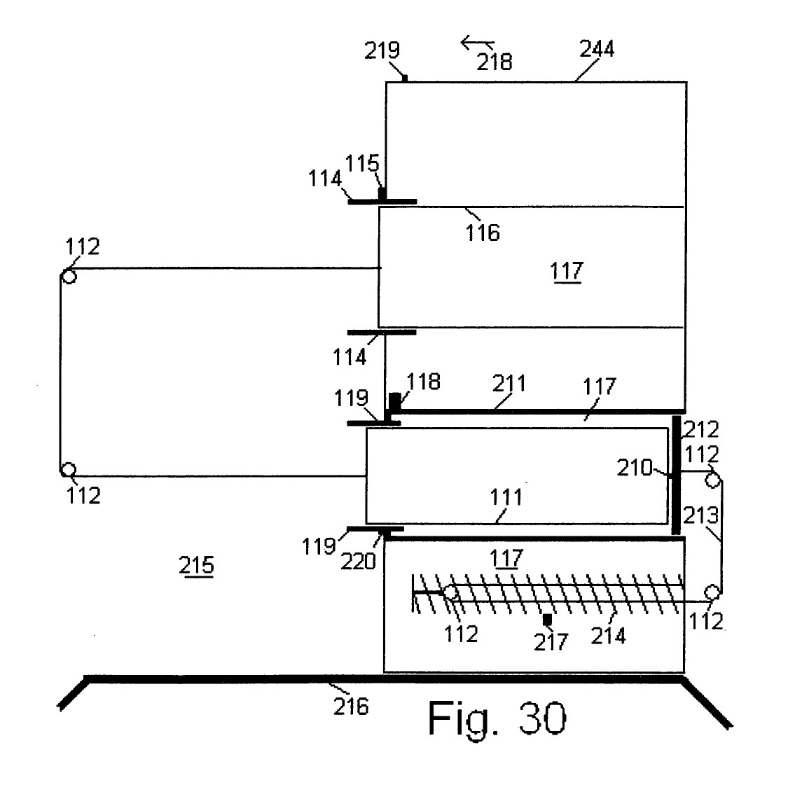

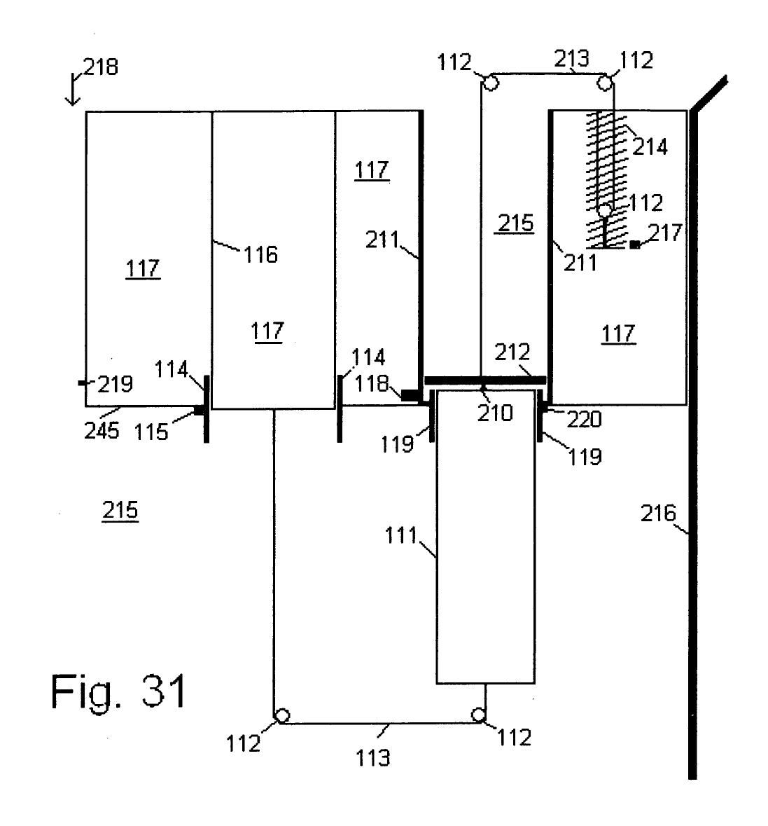

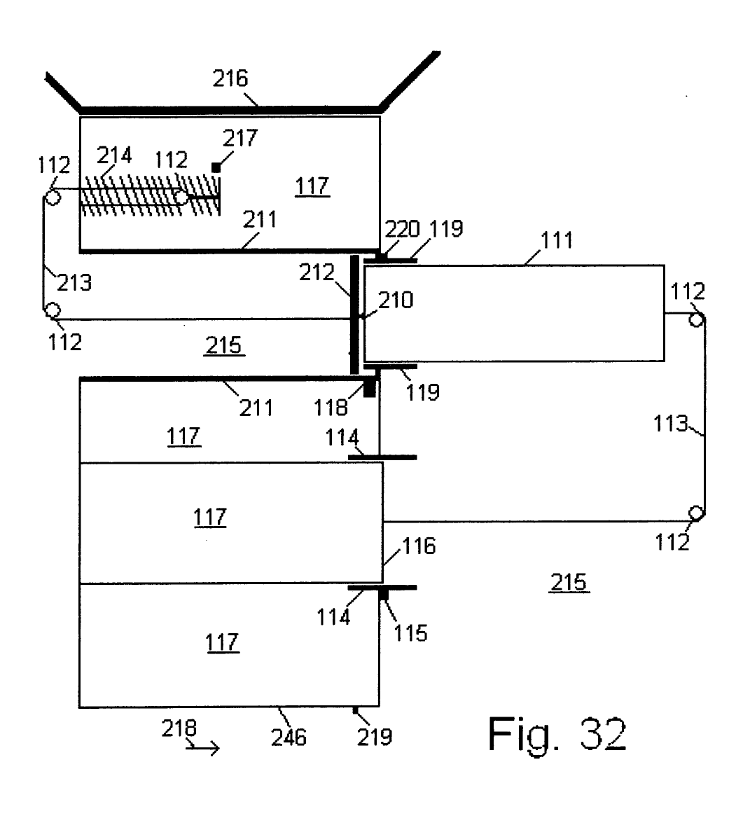

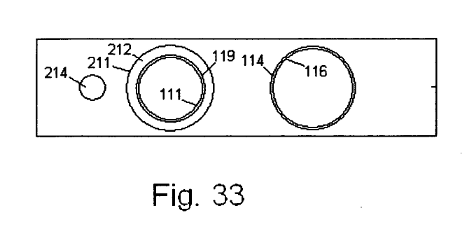

Number 1 is a piston-like tank full of liquid (1) in the un-expanded position.
Number 2 is a piston-like tank full of liquid (2) in the expanded position.
Number 3 is a retractable stop.
Number 4 is the starting position for the original machine.
Number 5 is a stop,
Number 6 is where the piston-like tank full of liquid in the expanded position (2) attaches to the load.
Number 7 is where the piston-like tank full of liquid in the expanded position (2) is released from the load.
Number 8 is the upper stop.
Number 9 is the load.
Number 10 is the track.
Number 11 is the liquid outside the piston-like tank.
Number 12 is a large tank full of liquid (11).
Number 20 is the start of the improvements.
Number 20 is the Piston-in-a-tank with the piston (35) in the down position.
Number 21 is the Piston-in-a-tank with the piston (34) in the up position.
Number 22 is the start position on the flow chart. (FIG. 5)
Number 23 is a generator.
Number 24 is the top transfer solenoid.
Number 25 is the bottom transfer solenoid
Number 26 is the collapsible stop.
Number 27 is the liquid line.
Number 28 is the gas breather tube.
Number 29 is a the rigid track.
Number 31 and 32 are arrows indicating direction of movement.
Number 33 is the liquid inside the Piston-in-a-tank (20,21).
Number 34 is the piston in the up position.
Number 35 is the piston in the down position.
Number 36 is the bottom door in the closed position.
Number 37 is the heavy metal weight.
Number 38 is the bottom door in the open position.
Number 39 is a liquid (33) passage.
Number 40 is a sump pump with a heavy metal weight.
Number 41 is a pressure equalizer valve
Number 42 is a float for the bottom door.
Number 43 are valves to let liquid (11) in.
Number 44 are cylinder walls with a seal and lock for the piston (35).
Number 45 is a return spring for the sump pump.
Number 46 is a combination retractable stop and gas valve in the extended position.
Number 47 is the gas inside the Piston-in-a-tank (20,21) and the breather tube (28) and collapsible stop (26,55).
Number 48 is a combination retractable stop and gas valve in the retracted position.
Number 49 is the top gas valve in the collapsible stop (26) in the open position.
Number 50 is the top part of the collapsible stop (26,55).
Number 51 is the return spring in the collapsible stop (26) in the extended position.
Number 52 is a arrow indicating direction of movement.
Number 53 is the bottom valve in the collapsible stop (26) in the closed position.
Number 54 is the top gas valve in the collapsible stop (55) in the closed position.
Number 55 is the collapsible stop in the collapsed position.
Number 56 is the bottom valve in the collapsible stop (55) in the open position.
Number 57 is the return spring in the collapsible stop (55) in the un-extended position.
Number 58 is a arrow indicating direction of movement.
Number 60 is a pressure powered sump pump. When the collapsible stop (26) collapses the increasing gas (47) pressure forces any liquid (11) in the collapsible stop (55) out.
Number 61 is a heat exchanger. (FIG. 5)
Number 62 is a radiator
Number 63 is a large tank
Number 64 is the return line for the radiator (62).
Number 65 is the intake line for the heat exchanger (61)
Number 66 is a pump.
Number 67 is a line from the heat exchanger (61) to the radiator (62)
Number 68 are transfer solenoids arranged in a cycle. (FIG. 7) The falling Piston-in-a-tank (21) must be removed from the bottom position and added to the top position as quickly as they fall, the rate they fall will determine the number of transfer solenoids (68) and combination rigid track (29), generator (23), and Piston-in-a-tank (20). (69)
Number 69 is a combination rigid track (29), generator (23), and Piston-in-a-tank (20).
Number 70 is push-rod for the bottom solenoid. (25)
Number 71 is the suction cup for the bottom solenoid (25)
Number 72 are one way valves on the suction cup (71).

### DETAILED DESCRIPTION OF THE INVENTION

A brief description of the original invention.

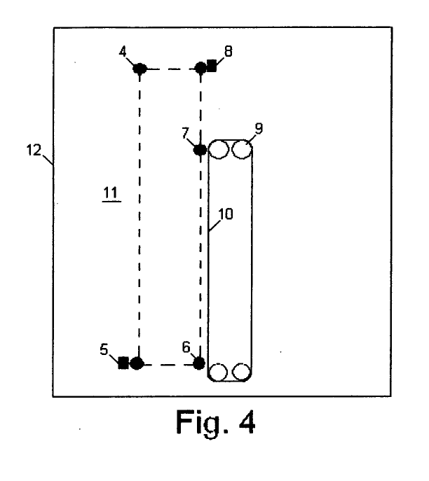

Starting at number 4 in FIG. 4 the piston-like tank full of liquid in the un-expanded position (1) begins to free-fall thru the liquid (11) in the tank (12) until it gets to number 5. At number 5 the piston-like tank full of liquid in the un-expanded position (1) is abruptly stop by the retractable stop (3) and it turns into the piston-like tank full of liquid in the expanded position (2). It is than transferred to position number 6 where it is attached to a track (10) that drives the load (9). It than floats up doing work until it gets to position 7. At position 7 the piston-like tank full of liquid in the expanded position (2) is released from the load (9) and aloud to accelerate up until it gets to the upper stop (8) where it is abruptly stopped and turns back into the piston-like tank full of liquid in the un-expanded position (1). It is than transferred to position number 4 and the cycle is complete.

### Machine Number One;

The improvements are as follows;

1. The piston-like tanks full of liquid (1) are no longer full of liquid (11). The liquid (11) has been replaced by a heavy metal weight (37) and gas (47).

2. The Piston-in-a-tank (21) no longer fall individually. The Piston-in-a-tank (21) now fall as a continuous column, greatly reducing the drag.

4. There is a breather tube (28), the breather tube allows more gas (47) into the expanding tank.

5. There are transfer solenoids (24,25,68)

6. There is a sump pump (40) and a gas valve (46) to remove any liquid (11) or gas (47) that accumulates in the tank.

7. There is a collapsible stop (26) that forces gas (47) into the Piston-in-a-tank (21). NOTE—The liquid (11) outside the Piston-in-a-tank (20,21) and the liquid (33) inside the Piston-in-a-tank could be water, and the heavy metal weight (37) could be lead. Water weights about 62 lbs/cubic ft. If the total displacement for the Piston-in-a-tank is 1 cubic ft, than the weight distribution would be about 60 lbs for the piston (34 and 35). Almost all the weight is in the piston. (34 and 35). The piston (34 and 35) needs to be lighter than the liquid (33) it displaces.

In the starting position the Piston-in-a-tank (20) weighs more than the liquid (11) it displaces.

The liquid (33) does not add any weight to the Piston-in-a-tank (21). END OF NOTE Starting at position 22 on the flow chart (FIG. 5) The Piston-in-a-tank (21) is heavier than the liquid (11) it displaces, The piston (34) is in the up position. The bottom area of the Piston-in-a-tank (21) is full of the liquid (33) and the bottom door (36) is closed.

The Piston-in-a-tank (21) is released from position 22 and aloud to free-fall until it gets to position 27 on the flow chart. The Piston-in-a-tank (21) fall as a continuous column greatly reducing the drag between the Piston-in-a-tank (21) and the liquid (11)

As the Piston-in-a-tank (21) fall they accelerate do to the force of gravity, both the heavy metal weight (37) and the liquid (33) in the Piston-in-a-tank (21) build momentum.

At position 27 the Piston-in-a-tank (21) is quickly pushed over to the collapsible stop (26) by the bottom transfer solenoid (25). The collapsible stop (26) abruptly stops the Piston-in-a-tank (21).

Three main things happen at position 27. One—as the collapsible stop (26) collapses it forces the gas (47) thru valve (46) into the Piston-in-a-tank (21) helping to push the piston (34) down. Two—The momentum of the liquid (33) causes it to keep going after the Piston-in-a-tank (21) is abruptly stopped. The momentum of the liquid (33) helps pull the piston (34) down. Three—The momentum of the heavy metal weight (37) causes the piston (34) to move down. The combination of the three above forces causes the Piston-in-a-tank (21) with the piston (34) in the up position to turn into the Piston-in-a-tank (20) with the piston (35) in the down position.

After the piston (35) moves down the piston locks (44) lock it in the down position. The bottom door (38) is closed by the float (42).

Just before impact between the Piston-in-a-tank (21) and the collapsible stop (26) the combination gas valve retractable stop (48) pops out. When the Piston-in-a-tank (20) starts up the retractable stop (46) goes back in the Piston-in-a-tank (20).

When the piston (34) moves down the displacement of liquid (11) increases. The Piston-in-a-tank (20) is now lighter than the liquid (11) it displaces and will float up doing work. Also at position 27 the weight on the sump pump (40) moves down and forces any liquid (11) in the Piston-in-a-tank (20) out. The return spring (45) lifts the weight after impact.

As the Piston-in-a-tank (21) falls from position 22 to position 27 the pressure on the inside and outside of the Piston-in-a-tank (21) is equalized by valve (41).

When the Piston-in-a-tank (21) impacts the collapsible stop (26) the upper valve (49) is opened and the bottom valve (53) is closed. After the Piston-in-a-tank (20) starts to float up the top valve (54) is closed and the bottom valve (56) is open. The return spring (57) returns the collapsible (55) stop to the expanded position (26). The return spring (57) must be strong enough to overcome the external pressure.

Next the Piston-in-a-tank (20) is attached to the rigid track (29) and floats up powering the generator (23). When the Piston-in-a-tank (20) gets near the top the valves (43) open to allow liquid (11) from outside in, the liquid (33) in the Piston-in-a tank (20) causes the piston (35) to float up returning the piston (35) to the up position. The Piston-in-a-tank (21) is now heavier than the liquid (11) it displaces and will sink. At the top position (22) the top transfer solenoid (24) pushes the Piston-in-a-tank (21) over and the cycle is complete. The cycle is repeated.

The bottom solenoid (25) does two things. 1) it pushes the falling Piston-in-a-tank (21) over into the collapsible stop (26). 2) It sucks the liquid (11) out of the way of the falling Piston-in-a-tank (21). When the bottom solenoid (25) changes from the extended position to the un extended position, it pulls back the suction cup (71), as the suction cup (71) is pulled back it sucks the liquid (11) out of the way of the falling Piston-in-a-tank (21).

### Specification Continued for Machine # Two

### BRIEF DESCRIPTION OF THE DRAWINGS

FIG. 18 is a side view of the tank (75) with the piston (81) in the un-extended position.

FIG. 19 is a side view of the tank (76) with the piston (80) in the extended position.

FIG. 20 is a side view of the tank (91) in the top position (93). With the piston (80) in the extended position.

FIG. 21 is the tank (92) after it changed from tank (91) at the top position (93).

FIG. 22 is a flow-chart for the machine.

FIG. 23 is a different version of a tank. In FIG. 23 the heavy metal weight (100) extends all the way across the top of the piston. Also there are bearings (103) between the heavy metal weight and the piston

FIG. 24 shows the heavy metal weight (100) falling all the way to the bottom of the extended piston. Also in FIG. 24 there is a return spring (102) for the extended piston.

FIG. 25 is a top view of the tank (75,76). The tank (75,76) is a cylinder.
Number 73 is the liquid.
Number 74 is a rigid track.
Number 75 is the tank with the piston (81) in the un-extended position.
Number 76 is the tank with the piston (80) in the extended position
Number 77 is the heavy metal weight in the top position.
Number 78 is the heavy metal weight in the bottom position.
Number 79 is a cable that attaches the heavy metal weight (77,78) to the piston (80,81)
Number 80 is the piston in the extended position.
Number 81 is the piston in the un-extended position
Number 82 is a combination retractable stop and gas valve in the retracted position.
Number 83 is a combination retractable stop and gas valve in the extended position.
Number 84 is a combination cylinder seal and piston (80) lock.
Number 85 is a movable pulley.
Number 86 is a bracket that connects the moveable pulley (85) to the piston (80,81)
Number 87 is a connector for the cable (79) to the heavy metal weight (77,78).
Number 88 is gas.
Number 89 are pulleys for the cable (79).
Number 90 are brackets that support the pulleys (89).
Number 91 is the tank at the top position (93) on the flow-chart (FIG. 22)
Number 92 is the tank at the top position (93) on the flow-chart (FIG. 22) after the piston has returned to the un-extended position.
Number 93 is the top position on the flow-chart.
Number 94 is a generator.
Number 95 is a combination stop and gas valve on the breather tube (97).
Number 96 are pulleys for the rigid track (74).
Number 97 is a breather tube.
Number 98 is the liquid (73) line
Number 99 is the transfer solenoid.
Number 100 is a heavy metal weight extending all the way across the top and bottom of a piston.
Number 101 is a top view of the outer profile of the tank (75,76)
Number 102 is a return spring for the extended piston (80).

### DETAILED DESCRIPTION OF THE INVENTION (MACHINE # TWO)

In the starting position the tank (92) must weight more than the liquid (73) it displaces. Also almost all of the weight of the tank (92) is in the heavy metal weight (77).

Starting at the top position (93) the tank (92) is detached from the rigid track (74) and allowed to free fall, as the tank (75) falls its velocity and momentum increase due to the force of gravity. The tanks (75) fall in a continuous column greatly reducing the drag.

The tank (75) accelerates down until it gets to the transfer solenoid (99). At the transfer solenoid (99) the tank (75) is pushed over to the combination stop and gas valve (95) and is abruptly stopped. The heavy metal weight (77) does not stop, it keeps going.

The combination of the momentum of the heavy metal weight (77) and the mechanical advantage gained from the moveable pulley (85) should be enough to move the piston (81) out of the tank (75)

As the heavy metal weight (77) falls it pulls the cable (79), as the cable (79) is pulled it causes the moveable pulley (85) to move down pulling the piston (81) out of the tank (75).

The tank (76) is now lighter than the liquid (73) it displaces and will float up doing work. Next the tank (76) is transferred over to the rigid track (74) and floats up powering the generator (94).

When the tank (91) gets to the top position (93) it changes from a tank (91) with the piston (80) in the extended position to a tank (92) with the piston (81) in the un-extended position. The external liquid ((73) pressure pushes the piston (80) back into the tank (91) A return spring (102) helps pull the piston (80) in. Also at the top position (93) any extra gas (88) is vented thru the gas valve (82). The tank (92) is now heavier than the liquid (73) it displaces and will sink. The cycle is complete. The cycle is repeated.

### Note

The tanks (75) must be removed from the bottom position as quickly as they fall. Also the tanks (92) must be add to the top position (93) as quickly as they fall.

### Specification Continued for Machine # Three

### BACKGROUND OF THE INVENTION

### Field of the Invention

The present invention relates to energy production, more particularly converting gravity to mechanical energy and heat.

### BRIEF SUMMARY OF THE INVENTION

The amount of buoyancy a object has is based on the amount of liquid the object displaces, and the weight of the object. If a submersed object increases in size its buoyancy increases, and if a submersed object decreases in size its buoyancy decreases. A submersed object that weights the same as the liquid it displaces will have neutral buoyancy. If the size of a object with neutral buoyancy increases the object will float-up doing work, and if the size of a object with neutral buoyancy decreases the object will sink also doing work.

This machine attempts to change the size of a submersed object with neutral buoyancy using only gravity as the energy source.

### BRIEF DESCRIPTION OF THE DRAWINGS

FIG. 26 is a flow-chart for the machine.

FIG. 27 is a tank-car with neutral buoyancy. The cylinder full of heavy metal (111) is extended out of the tank-car (247). The cylinder full of gas (116) is inside the tank-car (247) The piston (212) is in the starting position.

FIG. 28 is a tank-car (242) with positive buoyancy, The cylinder full of heavy Metal (111) has fallen down into the tank-car (242), pulling the cylinder full of gas (116) out of the tank-car. The cylinder full of gas (116) has greater volume than the cylinder full of heavy-metal (111).

FIG. 29 is a tank-car (243) in the top position (224) on the flow-chart.

FIG. 30 is the tank-car (244) changing from positive to negative buoyancy. The cylinder full of gas (116) is now inside the tank-car.

FIG. 31 is the tank-car (245) with negative buoyancy. The cylinder full of heavy Metal (111) attached to the piston (212) has fallen out of the tank-car. Spring (214) is compressed. The tank-car (245) is past (225) on the flow-chart.

FIG. 32 is the tank-car (246) in the bottom position. (222) on the flow-chart

FIG. 33 is a top view of the tank-car.

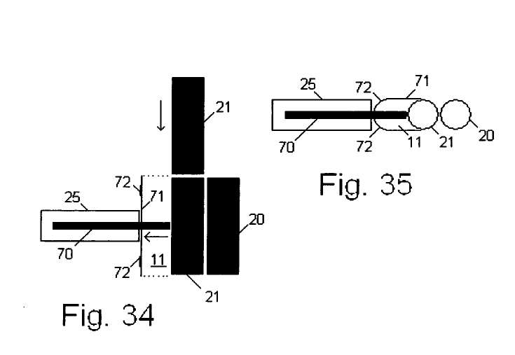

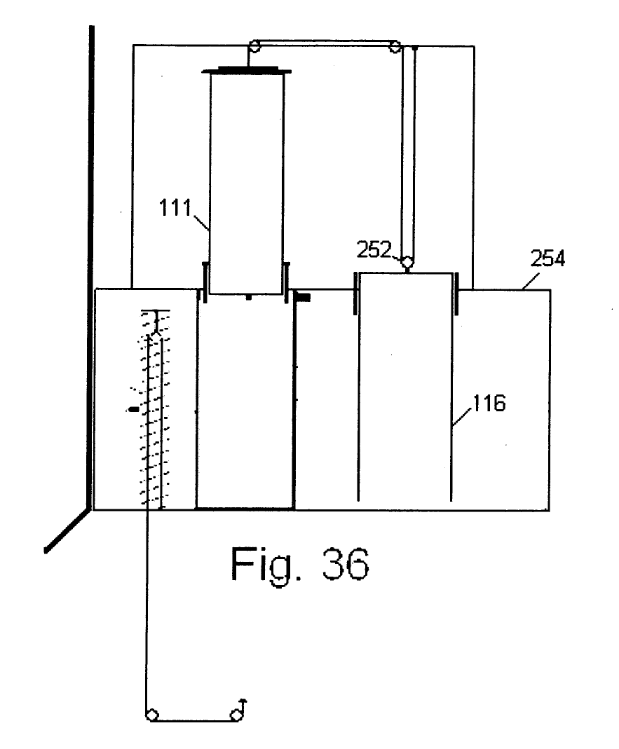

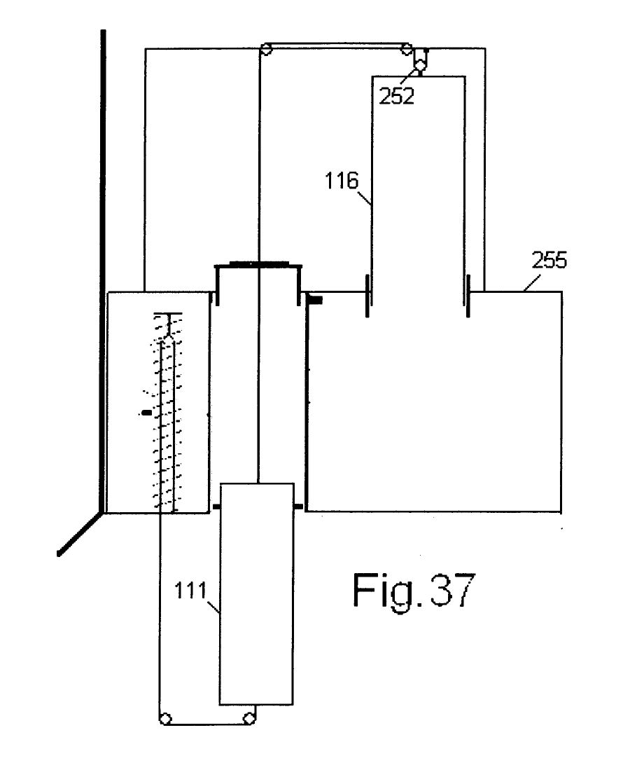

FIG. 36 and FIG. 37 are variations of machine #3.
Number 111 is a cylinder full of heavy metal.
Number 112 are pulleys.
Number 113 is a cable from the cylinder full of heavy metal (111) to cylinder full of gas (116).
Number 114 is a cylinder wall with a seal.
Number 115 is a lock for the cylinder full of gas (116).
Number 116 is the cylinder full of gas.
Number 117 is the gas inside the tank-car.
Number 118 is a gas valve.
Number 119 is a cylinder wall with a seal and a lock for the cylinder full of heavy metal (111).
Number 210 is a connector for the cylinder full of heavy metal (111) to the piston (212).
Number 211 is the cylinder wall for the piston (212)
Number 212 is a piston with a seal.
Number 213 is a cable connecting the piston (212) to the spring (214).
Number 214 is a spring.
Number 215 is the liquid this machine is submersed in.
Number 216 is a rigid track
Number 217 is a stop for the spring (214) when it is compressed.
Number 218 are arrows indicating direction of movement.
Number 219 is a gas intake valve.
Number 220 is a valve that lets liquid (215) out of the tank-car.
Number 221 is a line indicating the liquid level.
Number 222,223,224,225 indicate positions on the flow-chart.
Number 226 is a generator
Number 242 is the tank-car with positive buoyancy. The cylinder full of heavy metal (111) is in the tank-car, and the cylinder full of gas (116) is extended out of the tank-car.
Number 243 is the tank-car in the top position (224) on the flow chart.
Number 244 is the tank-car after it changes from positive to negative buoyancy. The cylinder full of gas (116) is now inside the tank-car.
Number 245 is the tank-car with negative buoyancy. The cylinder full of heavy metal (111) attached to the piston (212) has fallen out of the tank-car.
Number 246 is the tank-car at the bottom position (222). The piston (212) is still attached to the cylinder full of heavy metal (111).
Number 247 is the tank-car back to the starting position. The tank-car now has neutral buoyancy. The piston (212) has been released from the cylinder full of heavy metal (111)
Number 252 is a moveable pulley. FIGS. 34 and 35
Number 254 is the tank-car with the heavy metal weight (111) above the tank-car.
Number 255 is the tank-car after the heavy metal weight (111) falls thru it.

### DETAILED DESCRIPTION OF THE INVENTION

NOTE—The liquid (215) could be water, and the heavy metal could be lead. Water weights about 62 lbs/cubic ft. If the total displacement for the tank-car is one cubic ft. than the weight distribution would be about 60 lbs for the cylinder full of heavy metal (111), and about 2 lbs. for the rest of the tank-car. Almost all of the total weight of the tank-car is in the cylinder full of heavy metal (111).

### End of Note

Starting at position (222) on the flow-chart, tank-car (247) has neutral buoyancy. The weight of the tank-car (247) equals the weight of the liquid (215) displaced. The cylinder full of heavy metal (111) is extended out of the tank-car (247) and the cylinder full of gas (116) is in the tank-car (247). The tank-car (247) is pulled along by the track (216) past the (223) position on the flow-chart. As the tank-car (247) turns

and starts up, the cylinder full of heavy metal (111) starts to fall down to the inside of the tank-car (242) At this point tank-car (247) starts to turn into tank-car (242). As the cylinder full of heavy metal (111) falls it pulls the cable (113) attached to the cylinder full of gas (116). The tank-car (242) now looks like FIG. 28. The cylinder full of gas (116) is now extended out of the tank-car (242). The volume of the liquid (215) displaced by the cylinder full of gas (116) is greater then the volume of Liquid (215) displaced by the cylinder full of heavy metal (111) increasing the total displacement of the tank-car (242). At this point the tank-car (242) weights less
than the liquid (215) it displaces and floats-up doing work. Gas valve (118) allows Gas (117) pressure to equalize between different parts of the tank-car (242). Because the cylinder full of gas (116) has a larger volume than the cylinder full of heavy metal (111) the gas (117) pressure in the tank-car (242) is reduced when the cylinder full of gas (116) is removed.

Next the tank-car (242) moves to the top position (224) on the flow-chart. The stop for the cylinder full of gas (115) is released. When the tank-car (242) gets to position (224) it looks like tank-car (243) in FIG. 29. The tank-car (243) changes to tank-car (244) at position (224) on the flow-chart. The combination of the low gas (117) pressure inside the tank-car (243) and the external liquid (215) pressure causes the cylinder full of gas (116) to move back inside the tank-car (244). The valve (219) is now above the liquid line (221) any gas (117) that leaked out of the tank-car (244) will now be sucked into the low pressure and replaced. The tank-car (244) is now heavier than the liquid (215) it displaces and will sink doing work.

Next the tank-car (244) moves thru the (225) position on the flow-chart, as the tank-car (244) turns and starts to head down the cylinder full of heavy metal (111) starts to fall out pulling the piston (212) with it. As the piston (212) moves down it forces any liquid (215) that leaked into the tank-car (245) out thru the valve (220).

Also as the piston (212) moves down it pulls the cable (213) and that compresses the spring (214). The volume of liquid (215) that enters the tank-car (245) when the piston (212) is pulled down is greater than the volume of the cylinder full of heavy metal (111). The tank-car (245) displaces less liquid (215) than tank-car (244) did. The tank-car (245) sinks faster. The tank-car (245) now looks like FIG. 31 Next the tank-car (245) moves past the (222) position at the bottom of the flow-chart. At this point tank-car (245) turns into tank-car (246). Next the connector (210) releases the piston (212) from the cylinder full of heavy metal (111) and

the stop (217) releases the spring (214) The compressed spring (214) than pulls the piston (212) back to the starting position. As the piston (212) is pulled out of The tank-car (246) it creates a jet of liquid (215) It also creates a temporary low gas (117)
pressure that helps pull-in the cylinder full of heavy metal (111) in the next cycle. The cycle is now complete. The tank-car (247) now looks like FIG. 27 and has neutral buoyancy. The cycle is repeated.

NOTE—A variation of this machine is for the heavy metal weight (111) to fall from above the tank-car (254), thru the tank-car, and out the bottom of the tank-car. The heavy metal weight (111) would increase the displacement of the tank-car (255). Because the heavy metal weight (111) is falling further it would do more work pulling out a larger cylinder full of gas (116). Also because the heavy metal weight (111) is moving twice as far as the cylinder full of gas (116) a added moveable pulley (252) would give the heavy metal weight (111) a mechanical advantage. A breather tube is added to allow gas from the surface into the expanding tank.

1. I claim the following improvements to patent application Ser. No. 11/906,464 comprising; (MACHINE #1)
a) A Piston-in-a-tank (20) with the piston (35) in the down position FIG. 9
b) A Piston-in-a-tank (21) with the piston (34) in the up position
c) A generator (23)
d) A top transfer solenoid (24)
e) A bottom transfer solenoid (25) and its components (70) (71) (72)
f) A combination retractable stop and gas valve in the extended position (26) and its components (49) (50) (51) (53) (60)
g) A gas breather tube (28)
h) A rigid track (29)
I) A piston in the up position (34)
j) A piston in the down position (35)
k) A bottom door in the closed position (36)
l) A heavy metal weight (37)
m) A bottom door in the open position (38)
n) A liquid (33) passage (39)
o) A sump pump with a heavy metal weight (40)
p) A pressure equalizer valve (41)
q) A float for the bottom door (42)
r) Valves to let liquid (11) in (43)
s) Cylinder walls with a seal and lock (44)
t) A return spring for the sump pump (45)
u) A combination retractable stop and gas valve in the retracted position (55) and its components (54) (57) (56)
v) A heat exchanger (61) and radiator (62) and there components (66) (67) (64) (65)
w) A series of transfer solenoids arranged in a cycle (68).

2. (MACHINE #2)
a) A rigid track (74)
b) A the tank with the piston (81) in the un-extended position (75)
c) A tank with the piston (80) in the extended position (76)
d) A heavy metal weight in the top position (77)
e) A heavy metal weight in the bottom position (78)
f) A cable (79) that attaches the heavy metal weight (77,78) to the piston (80,81)
g) combination retractable stop and gas valve in the extended and retracted position (82) (83)
h) A combination cylinder seal and piston lock (84)
i) A movable pulley (85)
j) A bracket (86)
k) A connector (87)
l) Are pulleys (89)
m) Are brackets (90)
n) A generator (94)
o) A combination stop and gas valve (95) on the breather tube (97)
p) are pulleys (96) for the rigid track (74)
q) A breather tube (97)
r) A transfer solenoid (99)
s) A heavy metal weight extending all the way across the top and bottom of a piston (100)
t) A return spring (102) for the extended piston (80).

3. (MACHINE #3)
a) A cylinder full of heavy metal (111)
b) Are pulleys (112)
c) A cable (113)
d) A cylinder wall with a seal (114)
e) A lock (115)
f) A cylinder full of gas (116)
g) A gas valve (118)
h) A cylinder wall with a seal and a lock (119)
i) A connector (210)
j) A cylinder wall (211)
k) A piston with a seal (212)
l) A cable (213) 213 and 113 are different cables
m) A spring (214)
n) A rigid track (216)
o) A stop (217)
p) A gas intake valve (219)
q) A valve (220)
r) A generator (226)
s) A tank-car with positive buoyancy (242)
t) A tank-car with negative buoyancy (245)
u) A moveable pulley (252)
v) A tank-car (254) with the heavy metal weight (111) above the tank-car
w) A tank-car (255) after the heavy metal weight (111) falls thru it.

4. A process to convert gravity to mechanically energy and heat, comprising;
step 1 is submerging a tank using gravity
step 2 is increasing the buoyancy of the submersed tank using gravity
step 3 is floating the tank up doing work using gravity.
